(19) United States
(12) Patent Application Publication
(10) Pub. No.: US 2024/0426633 A1
(43) Pub. Date: Dec. 26, 2024

(54) Barometric Pressure Sensor Calibration Value Validation Using Altitude Contextualization

(71) Applicant: NextNav, LLC, Sunnyvale, CA (US)

(72) Inventors: Michael DORMODY, San Jose, CA (US); Wei LIU, Sunnyvale, CA (US)

(73) Assignee: NextNav, LLC, Sunnyvale, CA (US)

(21) Appl. No.: 18/742,241

(22) Filed: Jun. 13, 2024

Related U.S. Application Data
(60) Provisional application No. 63/509,096, filed on Jun. 20, 2023.

(51) Int. Cl. G01C 25/00; G01C 5/06

(52) U.S. Cl. CPC G01C 25/00; G01C 5/06

(57) ABSTRACT

A method involves measuring atmospheric pressure data using a barometric pressure sensor of a mobile device and determining an estimated position of the mobile device using positioning data. A calibration value for calibrating the barometric pressure sensor of the mobile device is determined using the atmospheric pressure data and added to a set of calibration values. If the estimated position of the mobile device corresponds to a location that has a wide distribution of possible altitudes, an aggregated calibration value overlap region and an aggregated calibration value range are generated using the set of calibration values. A set of validated calibration values are generated by validating the set of calibration values using a previously generated aggregated calibration value overlap region and a previously generated aggregated calibration value range. A combined calibration value is generated using the set of validated calibration values and used to calibrate the barometric pressure sensor.

### RELATED APPLICATIONS

This application claims priority to U.S. Provisional Patent Application No. 63/509,096, filed Jun. 20, 2023, all of which is incorporated herein by reference in its entirety.

### BACKGROUND

Determining the exact location of a mobile device (e.g., a smartphone operated by a user) in an environment can be quite challenging, especially when the mobile device is located in an urban environment or is located within a building. Imprecise estimates of the mobile device's altitude, for example, may have life-or-death consequences for the user of the mobile device since the imprecise altitude estimate can delay emergency personnel response times as they search for the user on multiple floors of a building. In less dire situations, imprecise altitude estimates can lead a user to the wrong area in an environment.

Different approaches exist for estimating an altitude of a mobile device. In a barometric-based positioning system, altitude can be computed using a measurement of atmospheric pressure from a calibrated barometric pressure sensor of a mobile device along with ambient pressure measurement(s) from a network of calibrated reference pressure sensors and a measurement of ambient temperature from the network or other source. The barometric pressure sensor of the mobile device is typically inexpensive and susceptible to drift over time. Consequently, the pressure sensor must be frequently calibrated. A typical approach for calibrating a barometric pressure sensor involves determining a calibration offset value that, when applied to a measurement of pressure by the pressure sensor, results in an estimated altitude that is within a tolerated amount of distance from the true altitude.

Unfortunately, the barometric pressure sensor of a mobile device cannot be calibrated at every location of the mobile device, especially when the mobile device is not at a known altitude (e.g., of a waypoint). Additionally, in some instances, an estimated position of the mobile device may be incorrect, or the estimated position of the mobile device may be correct, but retrieved terrain data (which may also include structural data) corresponding to the estimated position may be incorrect. Either of such scenarios can negatively impact the quality of a determined calibration value. However, calibration still must occur regularly despite the above issues.

### SUMMARY

In some aspects, the techniques described herein relate to a method, including: measuring, by one or more processors, atmospheric pressure data using a barometric pressure sensor of a mobile device; determining, by the one or more processors, an estimated position of the mobile device using positioning data received at the mobile device; determining, by the one or more processors, a calibration value for calibrating the barometric pressure sensor of the mobile device using the atmospheric pressure data; adding, by the one or more processors, the calibration value to a set of calibration values; determining, by the one or more processors, if the estimated position of the mobile device corresponds to a location that has a wide distribution of possible altitudes; upon determining that the mobile device is at a position that has a wide distribution of possible altitudes, generating, by the one or more processors, an aggregated calibration value overlap region and an aggregated calibration value range using the set of calibration values; generating, by the one or more processors, a set of validated calibration values by validating the set of calibration values using a previously generated aggregated calibration value overlap region and a previously generated aggregated calibration value range; generating, by the one or more processors, a combined calibration value using the set of validated calibration values; and calibrating, by the one or more processors, the barometric pressure sensor using the combined calibration value.

In some aspects, the techniques described herein relate to a method, including: measuring, by one or more processors, atmospheric pressure data using a barometric pressure sensor of a mobile device; determining, by the one or more processors, an estimated position of the mobile device; determining, by the one or more processors, a calibration value for calibrating the barometric pressure sensor of the mobile device using the atmospheric pressure data; adding, by the one or more processors, the calibration value to a set of calibration values; generating, by the one or more processors, a set of validated calibration values by validating the set of calibration values using a previously generated aggregated calibration value overlap region and a previously generated aggregated calibration value range; generating, by the one or more processors, a combined calibration value using the set of validated calibration values; and calibrating, by the one or more processors, the barometric pressure sensor using the combined calibration value.

### BRIEF DESCRIPTION OF THE DRAWINGS

FIG. 1 is a simplified view of an operational environment for barometric pressure sensor calibration value validation using altitude contextualization, in accordance with some embodiments.

FIG. 2 provides a simplified example of a portion of a process for altitude contextualization for calibrating a barometric pressure sensor of a mobile device, in accordance with some embodiments.

FIG. 3A shows a simplified side view of example buildings and select attributes, in accordance with some embodiments.

FIG. 3B shows a simplified side view of the example buildings of FIG. 3A with determined calibration values of a mobile device, in accordance with some embodiments.

FIG. 4 provides a simplified example graph illustrating how the individual calibration values introduced in FIG. 3B are used to generate a combined calibration value for a mobile device, in accordance with some embodiments.

FIG. 5 provides a graph of a distribution of example calibration confidence values determined using a barometric pressure sensor of a mobile device over time in a variety of locations within a region, in accordance with some embodiments.

FIG. 6 provides a graph of example results for determining a peak overlap of the calibration confidence values shown in FIG. 5, in accordance with some embodiments.

FIG. 7 provides a simplified topographic map of the bumpy or hilly terrain shown in FIG. 1, in accordance with some embodiments.

FIG. 8 shows a simplified example of a portion of a process for barometric pressure sensor calibration value validation using altitude contextualization, in accordance with some embodiments.

FIGS. 9-13 show simplified portions of the process shown in FIG. 8, in accordance with some embodiments.

FIG. 14 provides a simplified example graph illustrating how individual calibration values are validated, in accordance with some embodiments.

FIG. 15 illustrates the components of a transmitter, a mobile device, and a server of the operational environment shown in FIG. 1, in accordance with some embodiments.

### DETAILED DESCRIPTION

The barometric pressure sensor of a mobile device typically cannot be calibrated at every location of the mobile device—especially when the mobile device is not at a known altitude. One conventional approach is to limit calibration to opportunities when the mobile device is in a conducive environment for data collection, typically “SOFT” (Still, Outside, on Flat Terrain). Examples of such methods are described in U.S. Pat. No. 11,073,441, which was issued on Jul. 27, 2021, and is entitled “Systems and Methods for Determining When to Calibrate a Pressure Sensor of a Mobile Device”, all of which is incorporated herein by reference in its entirety for all purposes.

However, an estimated position of a mobile device is sometimes incorrect, and as such it may not be known with absolute certainty where a mobile device is located, especially when the mobile device is in a dense urban location. For example, in some situations, a mobile device may generate an estimated position that indicates that the mobile device is inside of a building when it is actually outdoors, or outdoors when it is actually inside of a building. Alternatively, the estimated position of a mobile device might indicate that the mobile device is within a different building than the one it is truly situated in. Even when an estimated position of a mobile device is correct, terrain and/or structural data corresponding to the estimated position may be incorrect or incomplete. For example, terrain data that includes structural information may indicate an incorrect height or elevation of surrounding terrain and/or an incorrect height of a building associated with the estimated position of the mobile device. For calibration techniques that rely on an assumed altitude of the mobile device to generate a barometric pressure sensor calibration value, any of the above discrepancies may introduce calibration errors.

Disclosed herein are methods to validate calibration values for a barometric pressure sensor of a mobile device using altitude contextualization techniques that are disclosed in U.S. Provisional Patent Application No. 63/489,957, filed Mar. 13, 2023, and corresponding U.S. patent application Ser. No. 18/599,901, filed Mar. 8, 2024, all of which are incorporated herein by reference in their entirety for all purposes. Depending on the outcome of a validation process, a candidate calibration value may either be added to, or retained within, a set of validated calibration values upon successful validation, or may be excluded or filtered from the set of validated calibration values if the validation is unsuccessful. In some embodiments, each calibration of the set of calibrations is validated and then added to the set of validated calibration values if the respective validation of that calibration value is successful. In other embodiments, all of the calibration values of the set of calibration values are first added to the set of validated calibration values and then individual calibration values are filtered from the set of validated calibration values if a respective validation of that calibration value is not successful. In either embodiment, the step of conditionally removing, and/or weighting calibration values to form the set of validated calibration values is referred to herein as “filtering” the calibration values.

The set of validated calibration values is used to generate a combined calibration value (i.e., a calibration value that was generated based on two or more calibration values) for calibrating a barometric pressure sensor of the mobile device. Thus, in some embodiments, candidate calibration values that are filtered from the set of validated calibration values do not contribute to the generated combined calibration value at all. In other embodiments, candidate calibration values that are filtered from the set of validated calibration values do not fully contribute to the generated combined calibration value (e.g., their contribution is weighted such that they contribute less to the generated combined calibration value generated using the validated set of calibration values as compared to candidate calibration values that were not filtered from the set of validated calibration values). In some embodiments, candidate calibration values that were initially filtered or excluded from the set of validated calibration values may later be added back to the set of validated calibration values, or may be weighted such that they contribute more to the generated combined calibration value based on new data that has been collected. For example, a candidate calibration value that was initially excluded or filtered from the set of validated calibration values because it was outside of a permissible range of calibration values may be re-evaluated as the permissible range of calibration values changes. Calibration value validation advantageously improves an overall calibration value accuracy for the barometric pressure sensor of the mobile device, thereby improving the accuracy of an estimated altitude of the mobile device.

### Altitude Contextualization for Calibrating a Barometric Pressure Sensor of a Mobile Device

An estimate of an altitude of a mobile device (h_{mobile}) can be computed by the mobile device, a server, or another machine that receives needed information as follows:

$${h}_{mobile} = {h}_{sensor} - \frac{R {T}_{remote}}{g M} ln ( \frac{{P}_{sensor}}{{P}_{mobile}} ) , \qquad ( Equation 1 )$$

where P_{mobile} is the estimate of atmospheric pressure at the location of the mobile device by a barometric pressure sensor of the mobile device, Pₛₑₙₛₒᵣ is an estimate of atmospheric pressure at the location of a reference pressure sensor that is accurate to within a tolerated amount of pressure from true pressure (e.g., less than 5 Pa), Tᵣₑₘₒₜₑ is an estimate of temperature (e.g., in Kelvin) at the location of the reference pressure sensor or a different location of a remote temperature sensor, hₛₑₙₛₒᵣ is an estimated altitude of the reference pressure sensor that is estimated to be within a desired amount of altitude error (e.g., less than 1.0 meters), g corresponds to the acceleration due to gravity, R is a gas constant, and M is the molar mass of air (e.g., dry air or other). The minus sign (−) may be substituted with a plus sign (+) in alternative embodiments of Equation 1, as would be understood by one of ordinary skill in the art. The estimate of pressure at the location of the reference pressure sensor can be converted to an estimated reference-level pressure that corresponds to the reference pressure sensor in that it specifies an estimate of pressure at the latitude and longitude of the reference pressure sensor, but at a reference-level altitude that likely differs from the altitude of the reference pressure sensor. The reference-level pressure can be determined as follows:

$${P}_{ref} = {P}_{sensor} \times exp ( - \frac{gM ( {h}_{ref} - {h}_{sensor} )}{R {T}_{remote}} ) , \qquad ( Equation 2 )$$

where Pₛₑₙₛₒᵣ is the estimate of pressure at the location of the reference pressure sensor, P_{ref} is the reference-level pressure estimate, and href is the reference-level altitude. The altitude of the mobile device h_{mobile} can be computed using Equation 1, where href is substituted for hₛₑₙₛₒᵣ and P_{ref} is substituted for Pₛₑₙₛₒᵣ. The reference-level altitude href may be any altitude and is often set at mean sea-level (MSL). When two or more reference-level pressure estimates are available, the reference-level pressure estimates are combined into a single reference-level pressure estimate value (e.g., using an average, weighted average, or other suitable combination of the reference pressures), and the single reference-level pressure estimate value is used for the reference-level pressure estimate P_{ref}.

The barometric pressure sensor of the mobile device used to determine an altitude estimate as described above is typically inexpensive and susceptible to drift over time. Consequently, the pressure sensor must be frequently calibrated. A typical approach for calibrating a pressure sensor determines a calibration offset value that, when applied to a measurement of pressure by the pressure sensor (P_{mobile}), results in an estimated altitude (h_{mobile}) that is within a tolerated amount of distance from the true altitude. Unfortunately, the barometric pressure sensor of a mobile device cannot be calibrated at every location of the mobile device, especially when the mobile device is not at a known altitude.

Disclosed herein is a process for calibration of a barometric pressure sensor of a mobile device using less than ideal data, especially data collected indoors or on bumpy terrain for which even a small error in a lateral position may produce a relatively large error in altitude, and which may be fairly common. As disclosed herein, a combined calibration value may be determined using two or more calibration values from a set of calibration values. In some embodiments, new calibration values are validated using techniques disclosed herein before being added to the set of calibration values. In other embodiments, a calibration value that is already a member of the set of validated calibration values may be validated and conditionally filtered from the set, or de-weighted, if the calibration value is not determined to be valid.

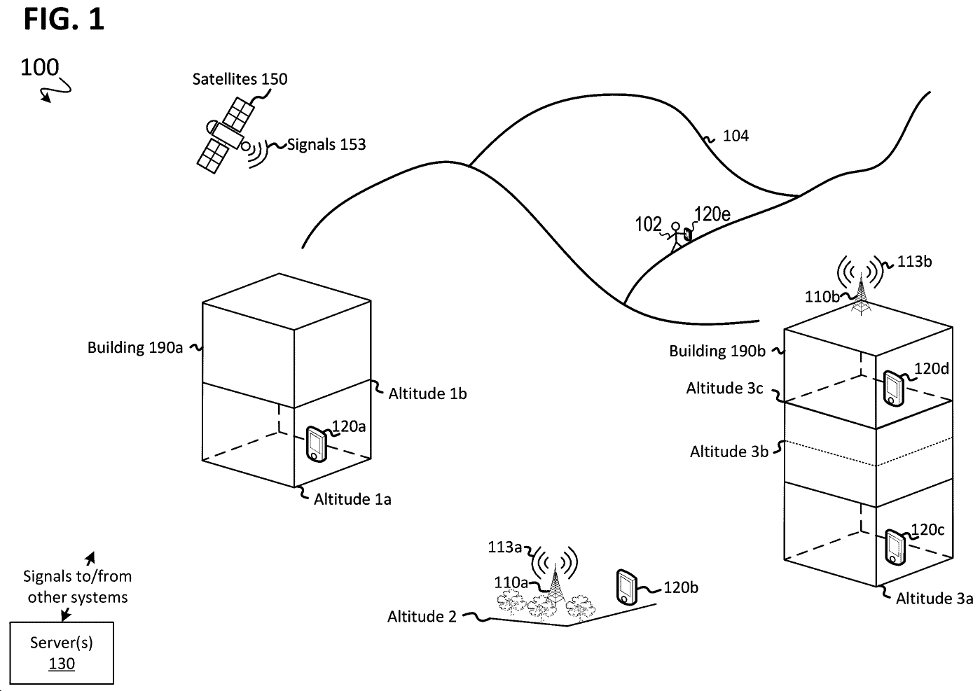

Attention is initially drawn to an operational environment 100 illustrated in FIG. 1, in accordance with some embodiments. The operational environment 100 includes a network of terrestrial transmitters 110a-b, buildings 190a-b, and mobile devices 120a-c. Also shown are signals 113a-b, 153, and altitudes designated as Altitudes 1a, 1b, 2, 3a, 3b, and 3c. A user 102 holding a mobile device 120e is shown on bumpy or hilly terrain 104 which varies in altitude. Each of the transmitters 110a-b and the mobile devices 120a-e may be located at different altitudes or depths that are inside or outside of the buildings 190a-b. The term “building” as used herein may refer to any structure having a known or determinable height (e.g., residential buildings, office buildings, monuments, museums, parking garages, shopping centers, venues, construction sites, schools, etc.). The positioning signals 113a-b and 153 are sent to the mobile devices 120a-e from the transmitters 110a-b and the satellites 150, respectively, using known wireless or wired transmission technologies. The transmitters 110a-b may transmit the signals 113a-b using one or more common multiplexing parameters—e.g. time slot, pseudorandom sequence, frequency offset, or other. Any of the mobile devices 120a-e may be implemented as a mobile phone, a tablet, a laptop, a tracking tag, a receiver, or another suitable device that can receive the positioning signals 113a-b and/or 153, and that has a barometric pressure sensor for determining a measurement of atmospheric pressure at a location of the mobile devices 120a-e. The mobile devices 120a-e usually include a respective temperature sensor where a temperature of the barometric pressure sensor or a battery is measured and which can roughly represent an internal temperature of the mobile devices 120a-c. Each of the transmitters 110a-b may also include a barometric pressure sensor and a temperature sensor that respectively measure atmospheric pressure and temperature at the location of the transmitters 110a-b. Measurements of atmospheric pressure and temperature can be used to compute an estimated altitude of the mobile devices 120a-e using Equation 1 as described above.

Conventionally, the pressure sensor of the mobile devices 120a-e cannot be calibrated at every location of the mobile device in the operational environment 100. For example, conventionally only the mobile device 120b, which is outdoors on flat terrain, would be considered to be in an appropriate location due to being at an altitude (Altitude 2) that is close to, or the same as, that of the surrounding terrain. By comparison, the mobile devices 120a, 120c, and 120d are indoors and therefore would not be calibrated using atmospheric pressure data measured by the barometric pressure sensors of those devices. Additionally, the mobile device 120e, which is located on the bumpy or hilly terrain 104, would not conventionally be considered to be in a location suitable for calibration.

In some conventional approaches, a barometric pressure sensor of a mobile device that is inside a building is calibrated assuming that the mobile device is at an altitude corresponding to half of the height of that building, as the true altitude of the mobile device within the building is unknown. That is, even though the mobile device 120a is on the ground floor of the building 190a at Altitude 1a, the barometric pressure sensor of the mobile device 120a would conventionally be calibrated assuming that the mobile device is at Altitude 1b, which corresponds to half of the building height of the building 190a. Similarly, the respective barometric pressure sensors of both the mobile devices 120c-d would be calibrated assuming that the mobile devices 120c-d were at Altitude 3b, which corresponds to half of the building height of the building 190b.

In some embodiments disclosed herein, other heights within a building besides the midpoint may be used as an assumed height. For example, in some embodiments, the highest or lowest height of a building may be used as the assumed height rather than the midpoint. In yet other embodiments, the height corresponding to the middle floor of a building may be used as an assumed height. The selection of which building height to use as an assumed height may be motivated by information such as knowledge that a particular floor, or range of floors, within a building may be inaccessible to a user. However, a known building height provides contextual information that can be used to convert indoor atmospheric pressure data into valuable opportunities to calibrate the barometric pressure sensor of a mobile device.

Calibration value validation, as disclosed herein, uses calibration values determined using a mobile device when the mobile device is at a location that has a wide distribution of possible altitudes to generate aggregated calibration value overlap and range values. The calibration value overlap and range values are subsequently used to validate calibration values that are determined using the mobile device when the mobile device is not at a location that has a wide distribution of possible altitudes. This is because the latter scenario should result in calibration values having calibration confidence values which are comparatively more tightly constrained. Because the calibration values are more tightly constrained, an error will advantageously be more readily apparent during validation.

In many scenarios, it is preferable to have no calibration value as compared to a bad calibration value. As such, a candidate calibration value will not be used for generating a calibration value for calibrating a barometric sensor of a mobile device, or will not fully contribute to the generated calibration value, based on an applied weight if the candidate calibration value is not determined to be valid. Conversely, the candidate calibration value may be used, or given more weight, for generating a calibration value of a mobile device if the candidate calibration value is determined to be valid.

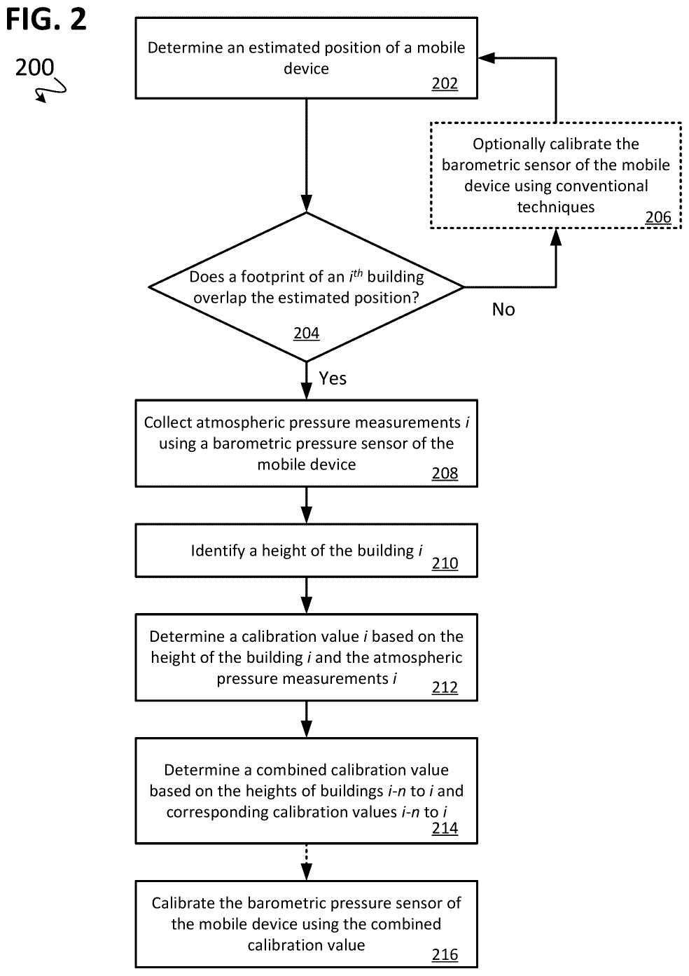

In the example operational environment shown in FIG. 1, the building 190b (since it has several floors) and the hilly terrain 104 are examples of locations having a wide distribution of altitudes, as compared to the location of the mobile device 120b. The building 190a (since it has few floors) could be considered to have a wide distribution of altitudes, or not, based on system design criteria. As mentioned above, validating a calibration value involves comparing the calibration value to an aggregated calibration value range and an aggregated calibration value overlap region associated with a set of calibration values. FIG. 2 through FIG. 7 describe a process for determining an aggregated calibration overlap value using altitude contextualization.

FIG. 2 provides a simplified example of a portion of a process 200 for altitude contextualization, in accordance with some embodiments. The particular steps, order of steps, and combination of steps are shown for illustrative and explanatory purposes only. Other embodiments can implement different particular steps, orders of steps, and combinations of steps to achieve similar functions or results.

At step 202, an estimated position of a mobile device is determined (e.g., using the signals 153 and/or 113a-b shown in FIG. 1). The estimated position may be a 2D or 3D location of the mobile device. At step 204 it is determined if a footprint of an i^{th} building (e.g., an i^{th} building of a set of buildings i-n through i which may be occupied by the mobile device across a range of dates and time) overlaps the estimated position of the mobile device. The set of buildings i-n through i may include instances of unique buildings as well as multiple instances of the same building (i.e., repeated visits to the same building).

A building footprint is a horizontal two-dimensional boundary that describes the outer perimeter of a building in the context of the surrounding terrain or in raw coordinates. In some embodiments, the estimated position is used to identify terrain data in a terrain database that includes structural data, such as building footprint data. In other embodiments, the estimated position is used to retrieve building footprint data directly from a database or dataset that may or may not contain surrounding terrain data.

In some embodiments, if the estimated position of the mobile device is sufficiently close to a building footprint, such as when a confidence value associated with the estimated position of the mobile device overlaps with the building footprint by a threshold amount, the mobile device is considered to be inside the building. In other embodiments, the mobile device is considered to be inside the building only if the estimated position of the mobile device is entirely within the outer perimeter of a building footprint. If it is determined at step 204 that the mobile device is not inside the i^{th} building, flow of the process 200 continues to optional step 206. At step 206, the barometric pressure sensor of the mobile device is optionally calibrated using conventional techniques (e.g., which may assume that the mobile device is outdoors and is close to the altitude level of the surrounding terrain surface). Flow of the process 200 then returns to step 202. If instead it was determined at step 204 that the footprint of the i^{th} building overlaps the estimated position of the mobile device, flow of the process 200 continues to step 208.

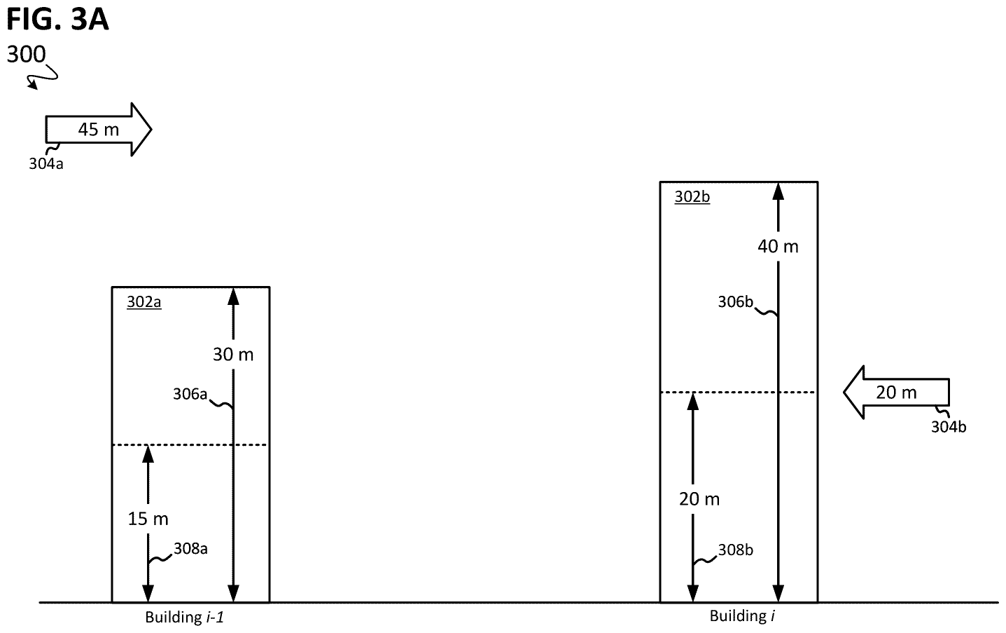

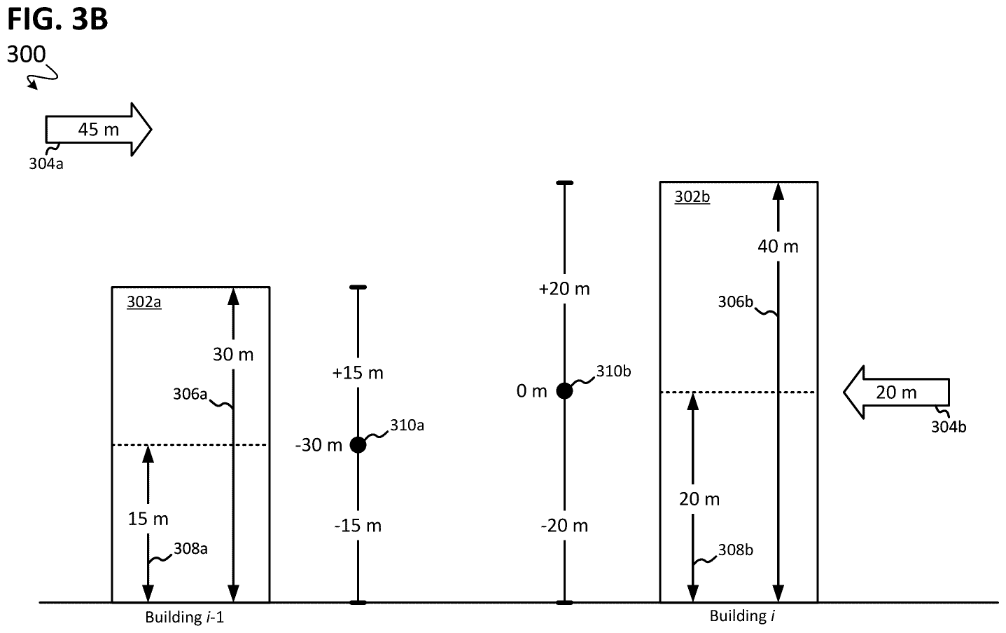

At step 208, an i^{th} set of atmospheric measurements are collected using a barometric pressure sensor of the mobile device inside of the i^{th} building. At step 210, a height of the i^{th} building is determined (e.g., using data retrieved from the terrain database at step 204). At step 212, an i^{th} calibration value for the barometric pressure sensor of the mobile device is determined based on the height of the i^{th} building, an estimated altitude of the mobile device determined using the i^{th} atmospheric pressure measurements, and an assumed altitude of the mobile device. As described below with reference to FIG. 3A, in some embodiments, the assumed altitude of the mobile device is an altitude that is equal to half of the building's height. In other embodiments, the assumed altitude of the mobile device is equal to the lowest or highest known altitude of the building. In either embodiment, the calibration value may be determined using a numerical difference between an uncalibrated estimated altitude determined using the barometric pressure sensor of the mobile device (as described with reference to Equation 1) and the assumed altitude of the mobile device. In some embodiments, multiple calibration values of a set of calibration values may be combined to determine the calibration value. In some such embodiments, the multiple calibration values may be combined using a weighted average. In other embodiments, the multiple calibration values may be combined using a polynomial function.

A calibration value, as referred to herein, is a set of values that includes a calibration offset value and a calibration confidence value (also referred to as a calibration range). The calibration offset value may represent an offset in atmospheric pressure or altitude that is applied to uncalibrated atmospheric measurements or uncalibrated altitudes, respectively. The calibration offset value may be expressed as a single value or as a polynomial. In some embodiments, the calibration values described herein may include one or more calibration coefficient values (e.g., of a polynomial calibration equation that takes various inputs such as temperature or pressure) and an associated calibration confidence value. The calibration confidence value represents a range of uncertainty of the calibration offset value.

In yet other embodiments, calibration values described herein may include both a calibration offset value and one or more calibration coefficient values as well as an associated calibration confidence value. Although calibration offset values are primarily referred to in the examples provided herein, it is understood that any of the calibration offset values could instead be a calibration polynomial depending on design preferences or design requirements of the associated calibration system.

At step 214, as described in detail below, a combined calibration value based on calibration values i-n to i and corresponding building heights i-n to i is determined at the mobile device and/or at a server. At step 216 the barometric pressure sensor of the mobile device is optionally calibrated, as indicated by the dashed arrow, using the combined calibration value.

Attention is now turned to FIG. 3A, which shows a simplified side-view 300 of example buildings 302a-b (labeled “Building i-1” and “Building i”, respectively). Also shown are uncalibrated mobile device altitude estimates 304a-b, building heights 306a-b, and assumed mobile device altitudes 308a-b. In the example shown, the mobile device altitude estimates 304a-b were determined using atmospheric measurements made by an uncalibrated barometric pressure sensor of the mobile device as inputs to a barometric formula such as the one shown in Equation 1. FIG. 3B shows the same simplified side-view 300 and the elements introduced in FIG. 3A, with the addition of a first calibration value 310a determined using an atmospheric pressure measurement made by a barometric pressure sensor of the mobile device while inside the building 302a, and a second calibration value 310b determined using an atmospheric pressure measurement made by the barometric pressure sensor of the mobile device while inside the building 302b. In the example shown, the calibration value 310a for the mobile device within the building 302a was determined using the mobile device altitude estimate 304a of 45 m, the known maximum building height of 30 m, and an assumed altitude 308a of 15 m (i.e., half of the 30 m building height) to arrive at a calibration offset value of −30 m with a calibration confidence value of +/−15 m. Similarly, the calibration value 310b for the mobile device within the building 302b was determined using the mobile device altitude estimate 304b of 20 m, the known maximum building height of 40 m, and an assumed altitude 308b of 20 m (i.e., half of the 40 m building height) to arrive at a calibration offset value of 0 m with a calibration confidence of +/−20 m. In some embodiments, the calibration offset value may be based on a vertical midpoint of floor altitude measurements which are spread across different levels in the building and the confidence may correspond to the range of possible floor altitudes for the building. Additionally, in some embodiments, if the estimated position of the mobile device is not well localized to a single building, then the calibration offset value could be a midpoint of the tallest building within the mobile device's vicinity, or the midpoint of a common building height within the mobile device's vicinity. Examples of such methods are described in U.S. Pat. No. 11,333,567, which was issued on May 17, 2022, and is entitled “Constraining Barometric Pressure Sensor Calibration with Sporadic Data Collection”, all of which is incorporated herein by reference in its entirety for all purposes.

In accordance with the calibration process disclosed herein, a calibration value that includes a calibration offset value and an associated calibration confidence value is determined for the mobile device within multiple buildings and/or the same building at multiple times, and then those calibration values are used in conjunction to determine a combined calibration value that is more precise than either of the calibration values individually.

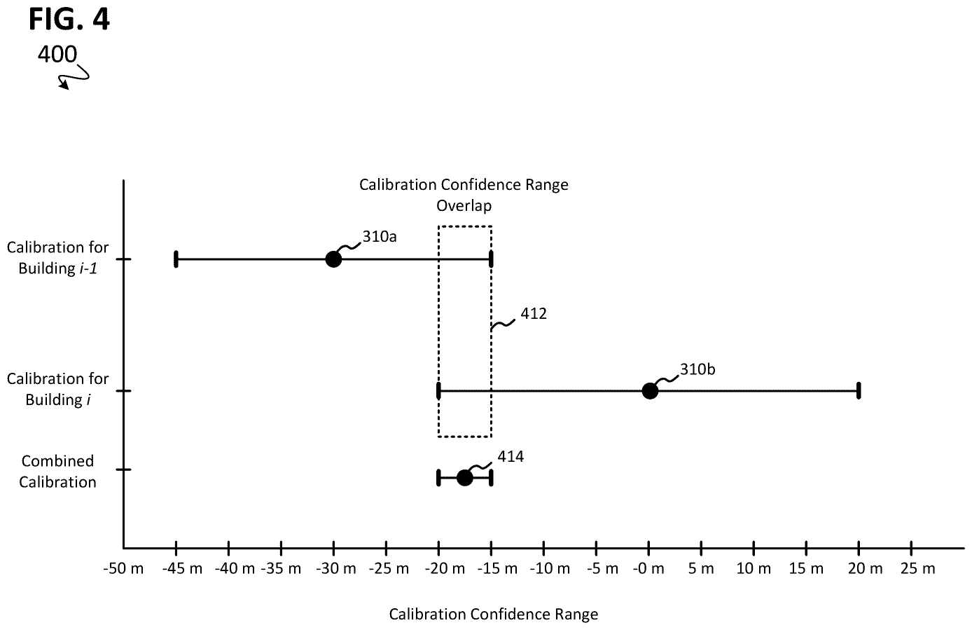

FIG. 4 provides a simplified example graph 400 illustrating how the individual calibration values 310a-b introduced in FIG. 3B are used to generate a combined calibration value, in accordance with some embodiments. As shown, the calibration value 310a has an offset of −30 m, and an associated confidence value that ranges from −45 m to −15 m (i.e., +/−15 m). By comparison, the calibration value 310b has an offset of 0 m, and an associated confidence value that ranges from −20 m to 20 m (i.e., +/−20 m). As shown in the graph 400, the calibration values 310a and 310b overlap each other in region 412. The overlap region 412 is advantageously used to generate a combined calibration value 414 having a calibration offset of −17.5 m (at the center of the overlap region) and an associated calibration confidence value of +/−2.5 m which is significantly more precise than either of the individual calibration values 310a-b.

Due to the varying quality of atmospheric pressure measurements made by the mobile device, among other factors such as floor separation assumptions, the calibration confidence values may just barely overlap, or may just barely not overlap. Thus, in some embodiments, a buffer and/or scaling factor may be applied to the calibration confidence values to facilitate the determination of the overlapping region. In some embodiments, the buffer may be selected based on floor separation values.

In some scenarios, the building height data used to determine the individual calibration values discussed above may not be accurate, and the way in which the building height data is inaccurate may impact the process for calibration value contextualization disclosed above. For example, while it may be accurately determined which building a mobile device is within, the building height data retrieved for that building may be incorrect. Or, the determination of which building the mobile device is within may be inaccurate, and then the building data retrieved is likely to not be accurate given the mobile device's true location. Additionally, in regions where there is little altitude diversity, meaning the user does not change floors in the same or different buildings within an acceptable time frame of interest, the overlap region may not shrink or converge to an acceptable range (e.g. ideally within 5 m or 50 Pa). That is, if the measurements within a building at different floors were made months apart, measurements of the barometric pressure sensor of the mobile device may have drifted, and thus such measurements are less useful than measurements made within a narrow time frame (e.g., minutes, hours, or days). As described below, calibration value validation using altitude contextualization advantageously identifies calibration values that are likely to be erroneous due to such inaccuracies in position estimation and/or terrain data.

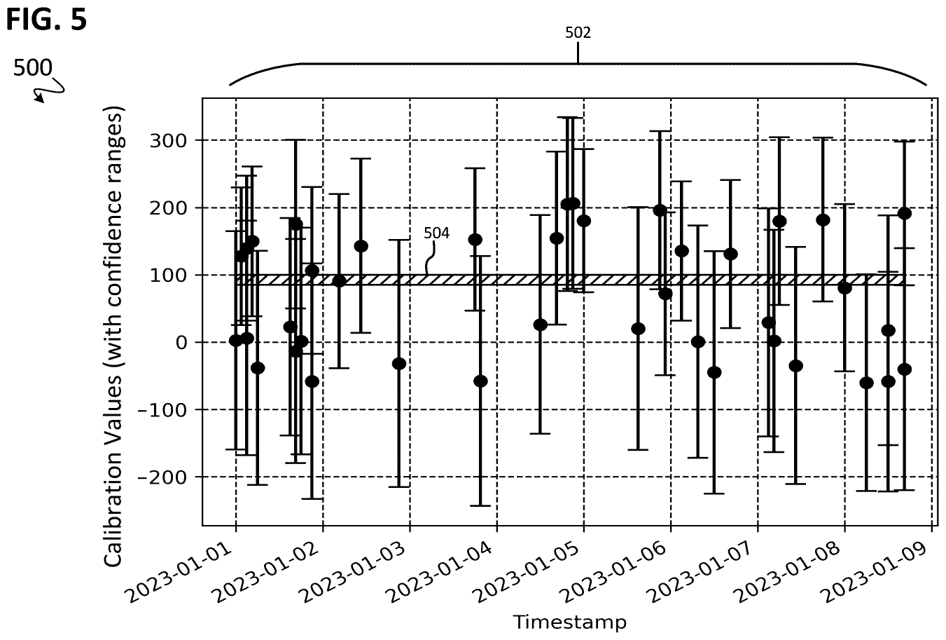

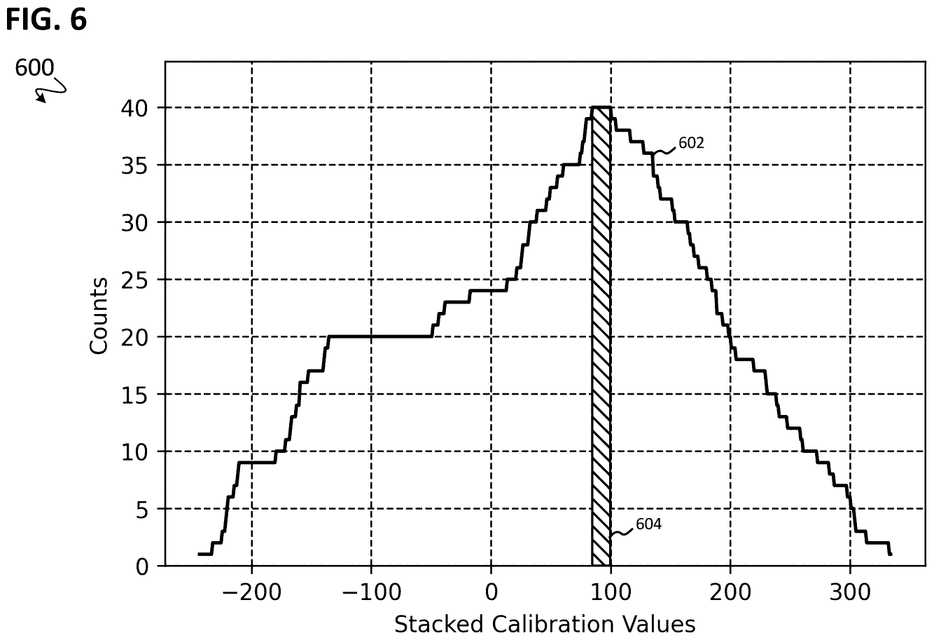

FIG. 5 provides an example graph 500 of a distribution of calibration offsets and calibration confidence ranges for a set of calibration values 502, in units of Pascals (or can equivalently be graphed in meters, as the translation between Pascals and meters is well known in the art), determined using a barometric pressure sensor of a mobile device over time in a variety of locations (i.e., within buildings and outdoors) within a region, in accordance with some embodiments. Also shown is a numerical range 504 that contains the greatest overlap of the calibration confidence ranges of the set of calibration values 502. The calibration confidence values were then used as input data to the process 200 shown in FIG. 2. FIG. 6 provides a graph 600 of example results 602 for determining an overlap of the calibration confidence values of the set of calibration values 502 shown in FIG. 5, in accordance with some embodiments. In the example shown in FIG. 6, the set of calibration values 502 of FIG. 5 were “stacked” to form a histogram 602 having a peaked value where the greatest amount of overlap occurred. A numerical range 604 indicates a known correct calibration range for the barometric pressure sensor. As shown in FIG. 6, the correct calibration region 604 occurs at the peak value of the histogram 602. In some embodiments, a resultant combined calibration offset value corresponds to the peak value of the histogram 602 and the combined calibration confidence value may be derived using a spread of the peak of the histogram 602, or a deviation from a central tendency thereof. In other embodiments, the combined calibration confidence value may occur within a threshold value of the peak value (e.g., within a spread of 30 Pa, or +/−15 Pa) and may not necessarily perfectly align with the peak calibration value.

In some embodiments, the process for altitude contextualization for calibrating a barometric pressure sensor, as disclosed above, may also be applied to data collected outdoors to advantageously calibrate mobile devices that are outdoors at an ambiguous altitude due to hilly/sloped (“bumpy”) terrain. So-called bumpy terrain that is traversable by people typically varies in elevation by no more than a few meters to 10 meters (i.e., corresponding to the quality of a typical mobile device 2D position estimate). By comparison, most buildings have floor separations on the order of 3-4 meters per floor, which means that for a tall building with a large number of floors, the altitude distribution could be very large. Thus, floor separations in buildings typically cause a wider distribution of possible altitudes than bumpy terrain alone.

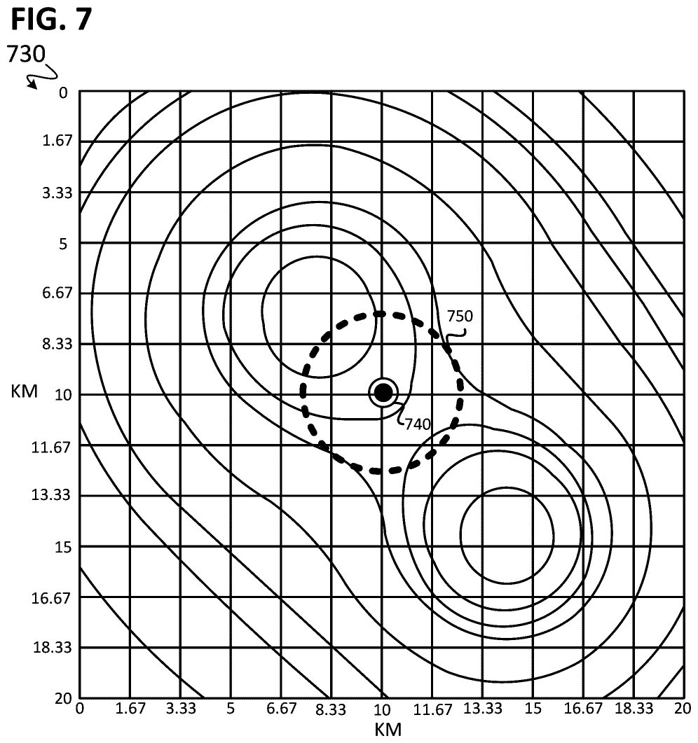

With reference to the bumpy or hilly terrain 104 shown in FIG. 1, when a mobile device is located at such terrain, an altitude estimate thereof may have some ambiguity due to a large terrain distribution within a 2D uncertainty region of the mobile device's estimated position. For example, FIG. 7 provides a simplified topographic map 730 of the hilly terrain 104 shown in FIG. 1, in accordance with some embodiments. A 2D position estimate 740 of the mobile device 120e has an associated 2D uncertainty region 750 which encompasses several changes in terrain elevation. Conventionally, mobile devices within such uneven terrain conditions are not at an ideal location for calibration. For example, U.S. Pat. No. 11,555,699, issued Jan. 17, 2023, and entitled “Systems and Methods for Determining When An Estimated Altitude of a Mobile Device Can Be Used For Calibration or Location Determination,” describes determining a flatness metric of an area and generating terrain distributions to determine if a location is well suited for calibrating the barometric pressure sensor of a mobile device.

Similar to the altitude contextualization process described above for indoor locations, calibration offset, and confidence values may be generated by the mobile device 120c using a midpoint altitude of a terrain distribution of the region surrounding the mobile device 120e as the assumed altitude, as well as the spread of the terrain distribution. For example, the midpoint could be the median of the distribution, and the spread could be the deviation from a central tendency. As the mobile device 120c travels through the region, additional calibration values may be generated using additional terrain distributions within the region. A set of calibration values i-n through i, corresponding to different or nearby terrain distributions i-n through i, may then be used by the mobile device and/or a server to determine an overlap region of the associated confidence values to generate a combined calibration value similar to as described above.

### Calibration Value Validation Using Altitude Contextualization for Calibrating a Barometric Pressure Sensor of a Mobile Device

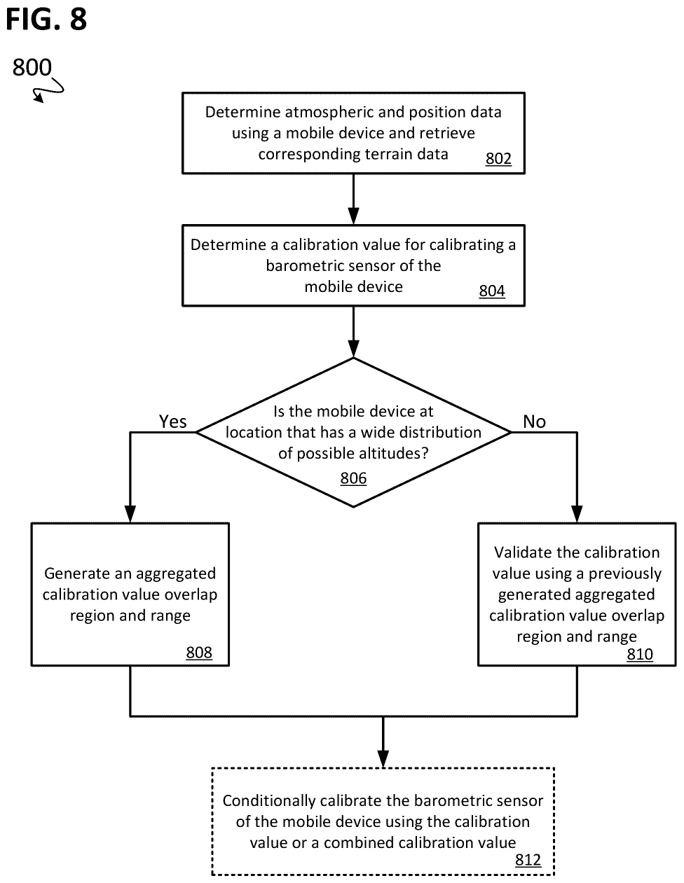

FIG. 8 shows a simplified example of a portion of a process 800 for calibration value validation using altitude contextualization for calibrating a barometric pressure sensor, in accordance with some embodiments. The particular steps, order of steps, and combination of steps are shown for illustrative and explanatory purposes only. Other embodiments can implement different particular steps, orders of steps, and combinations of steps to achieve similar functions or results.

At step 802, a mobile device collects atmospheric and position data and uses the position data to determine an estimated position of the mobile device, in accordance with some embodiments. In other embodiments, the mobile device may determine an estimated position of the mobile device using other methods, such as a beacon, near-field communication, or based on user input. Terrain data corresponding to the estimated position may be retrieved from a terrain database using the mobile device and/or at a server. The terrain data may include terrain elevations and/or altitudes, as well as altitude and/or height information associated with man-made structures such as buildings, parking structures, monuments, etc. As described above, such man-made structures are referred to generally as buildings herein.

The atmospheric data may include atmospheric pressure measurements made by a barometric pressure sensor of the mobile device. The position data may include ranging signals from terrestrial and/or satellite-based transmitters. The ranging signals may be used to perform multilateration of the mobile device to generate an estimated 2D or 3D position thereof, as is well understood in the art. The position data may alternatively include beacon/waypoint data received from beacons/waypoints at a known position to directly provide an estimated position of the mobile device.

At step 804, a calibration value for calibrating the barometric pressure sensor of the mobile device is determined. In some embodiments, the calibration value may be determined as described with reference to step 212 shown in FIG. 2. In other embodiments, the calibration value may be determined using other techniques that are known in the art, such as those described in U.S. Pat. No. 10,514,258, entitled “Systems and Methods for Calibrating Unstable Sensors”, which was issued on Dec. 24, 2019, all of which is incorporated herein by reference in its entirety for all purposes.

At step 806, the estimated position of the mobile device is used to determine if the mobile device generated the calibration value using pressure measurements made at a location that has a wide distribution of possible altitudes. Tall buildings and hilly terrain are examples of locations that have a wide distribution of possible altitudes. In some embodiments, a maximum possible altitude deviation associated with a building and/or terrain data at the location of the mobile device is compared to a threshold value to determine if the altitude deviation is considered to be a wide distribution. If the maximum possible altitude deviation partially or fully falls outside of the threshold value (e.g., by 1-sigma or 2-sigma), the location is considered to have a wide distribution of possible altitudes. If it was determined at step 806 that the mobile device generated the calibration value at a location having a wide distribution of possible altitudes, flow of the process 800 continues to step 808.

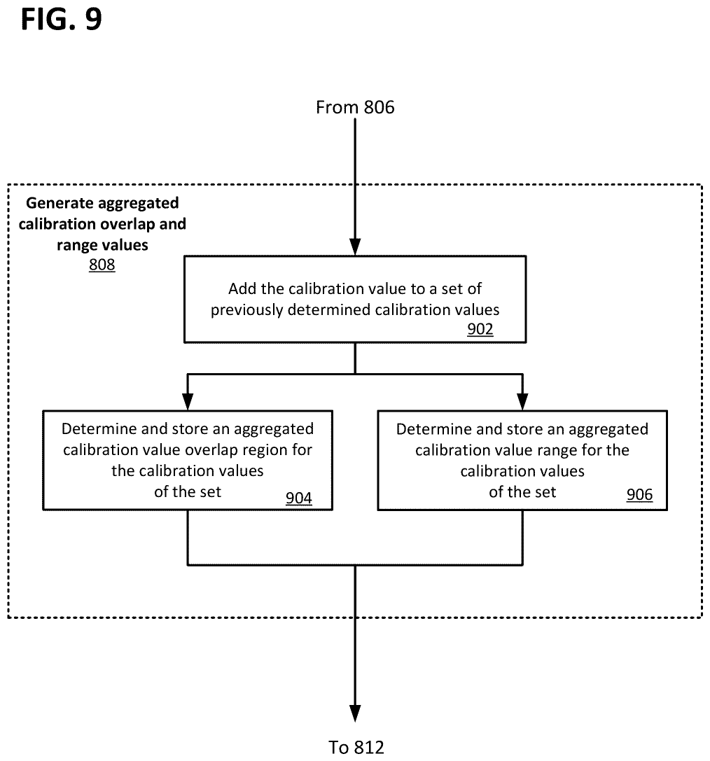

At step 808, the calibration value is used, along with other calibration values of a set of calibration values, to generate an aggregated calibration value range and aggregated calibration value overlap region. Details of step 808 are described below with reference to FIG. 9. Flow of the process 800 then continues to step 812, in which the barometric pressure sensor of the mobile device is conditionally calibrated using the validated calibration value, or a combined calibration value, as described above.

If it was determined at step 806 that the mobile device did not generate the calibration value at a location having a wide distribution of possible altitudes, flow of the process 800 continues to step 810. At step 810, the calibration value is validated using a previously generated aggregated calibration value overlap region and aggregated calibration value range as part of generating a set of validated calibration values. In some embodiments, the set of validated calibration values is generated by adding each calibration value from the set of calibration values to the set of validated calibration values upon a successful validation of that calibration value. In other embodiments, each calibration value of the set of calibration values is added to the set of validated calibration values and then filtered from the set of validated calibration values based on the validation success of each respective calibration value. In either embodiment, the conditional addition, removal, or weighting of a calibration value to generate the set of validated calibration values is referred to as “filtering” the calibration value.

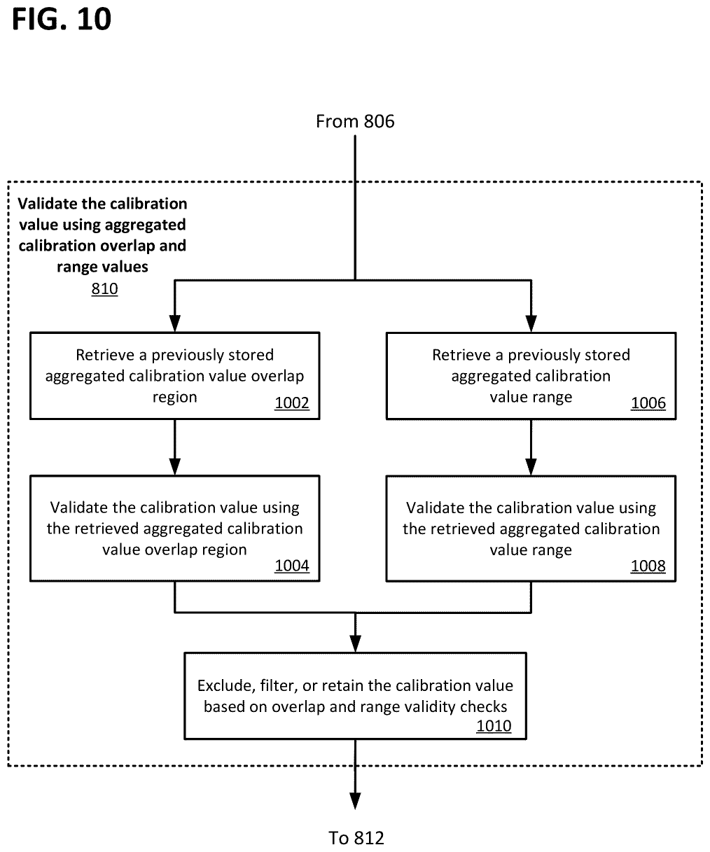

In some embodiments, validating a calibration value involves determining if the calibration value is within a predetermined threshold number of meters or Pascals (depending on the units used) of the aggregated calibration value overlap region and the aggregated calibration value range. For example, if a calibration value is within 10 Pascals, or the equivalent altitude thereof, of the aggregated calibration value overlap region or the aggregated calibration value range, the calibration value would be considered to be “within” the aggregated calibration value overlap region or the aggregated calibration value range. Details of step 810 are described below with reference to FIG. 10. Flow of the process then continues to step 812, whereupon the barometric pressure sensor of the mobile device is conditionally calibrated using the validated calibration value, or a combined calibration value as described above.

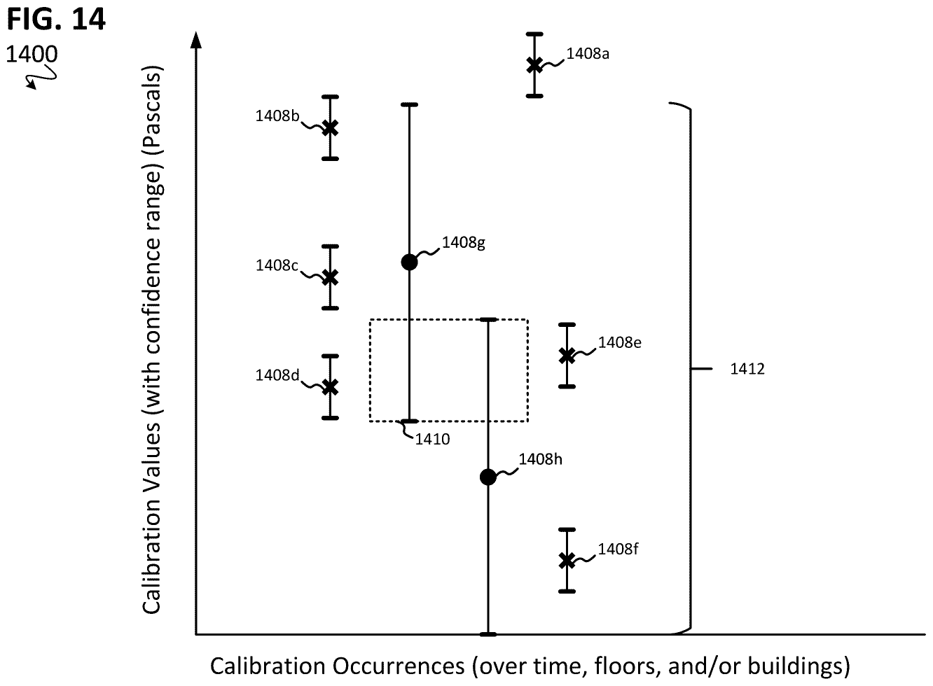

To illustrate the process for calibration value validation, FIG. 14 provides a simplified plot 1400 of a set of calibration values 1408a-h, an aggregated calibration value overlap region 1410 of calibration values 1408g-h, and an aggregated calibration value range 1412 of the calibration values 1408g-h, in accordance with some embodiments. The calibration values 1408a-h were generated at various times, building floors, and/or buildings. In the example shown, the calibration values 1408g and 1408h are associated with a location having a wide distribution of possible altitudes, as evidenced by each of the calibration values having a large respective calibration confidence value as compared to the calibration values 1408a-f. Thus, any of the calibration values 1408a-f may be validated using the set of calibration values 1408g-h, as described below.

FIG. 9 provides details for step 808 of the process 800 shown in FIG. 8 for generating an aggregated calibration value overlap region and an aggregated calibration value range, in accordance with some embodiments. The particular steps, order of steps, and combination of steps are shown for illustrative and explanatory purposes only. Other embodiments can implement different particular steps, orders of steps, and combinations of steps to achieve similar functions or results.

At step 902, the calibration value determined at step 804 of the process 800 is added to a set of previously determined calibration values. Steps 904 and 906 may then be conducted in parallel, in series, or in any order. At step 904, an overlap region is determined using the calibration value and the set of previously determined calibration values. After step 904, flow continues to step 812 shown in FIG. 8.

As described above, the overlap region is a numerical span in which the calibration confidence values of two or more calibration values numerically overlap with one another. For example, with reference to FIG. 14, the aggregated calibration value overlap region 1410 may be determined using the previously determined calibration values 1408g-h. However, due to various 2D position determination issues and/or building/terrain inaccuracies, there could be locations where the calibration values do not all overlap since one or more of the calibration values could be inaccurate. Thus, in some embodiments, it is assumed that the most significant overlap is the one that has averaged out any errors and is accurate.

Returning attention to FIG. 9, at step 906 an aggregated calibration value range is determined using the set of previously determined calibration values. The aggregated calibration value range is a combined measure of dispersion or spread of the calibration values in the calibration value dataset. In some embodiments, the aggregated calibration value range is calculated as the difference between the absolute maximum and absolute minimum values of the entirety of the calibration values in the calibration value dataset. In other embodiments, the aggregated calibration value range is the standard deviation (or some other measure of dispersion from a central tendency) of the calibration values in the calibration value dataset.

In the example shown in FIG. 14, the aggregated calibration value range 1412 has a minimum value that corresponds to a minimum value of the calibration confidence of the calibration value 1408h and a maximum value that corresponds to a maximum value of the calibration confidence of the calibration value 1408g. In some embodiments, if only one calibration value exists in the set of calibration values, or if multiple identical calibration values exist in the set of calibration values, the overlap and range values will be the same. After step 906, flow continues to step 812 shown in FIG. 8.

FIG. 10 provides details for step 810 of the process 800 shown in FIG. 8 for validating the calibration value using a previously generated aggregated calibration value overlap region and a previously generated aggregated calibration value range, in accordance with some embodiments. The particular steps, order of steps, and combination of steps are shown for illustrative and explanatory purposes only. Other embodiments can implement different particular steps, orders of steps, and combinations of steps to achieve similar functions or results.

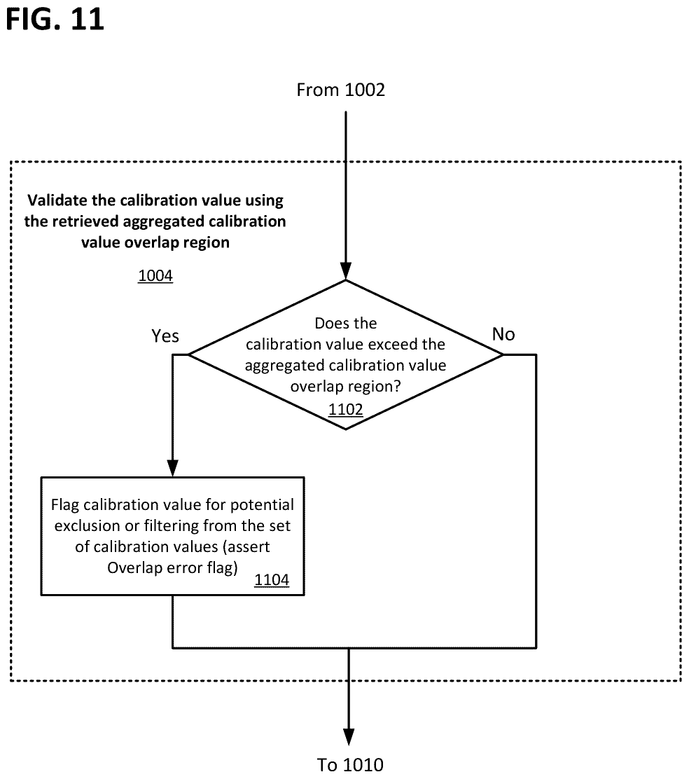

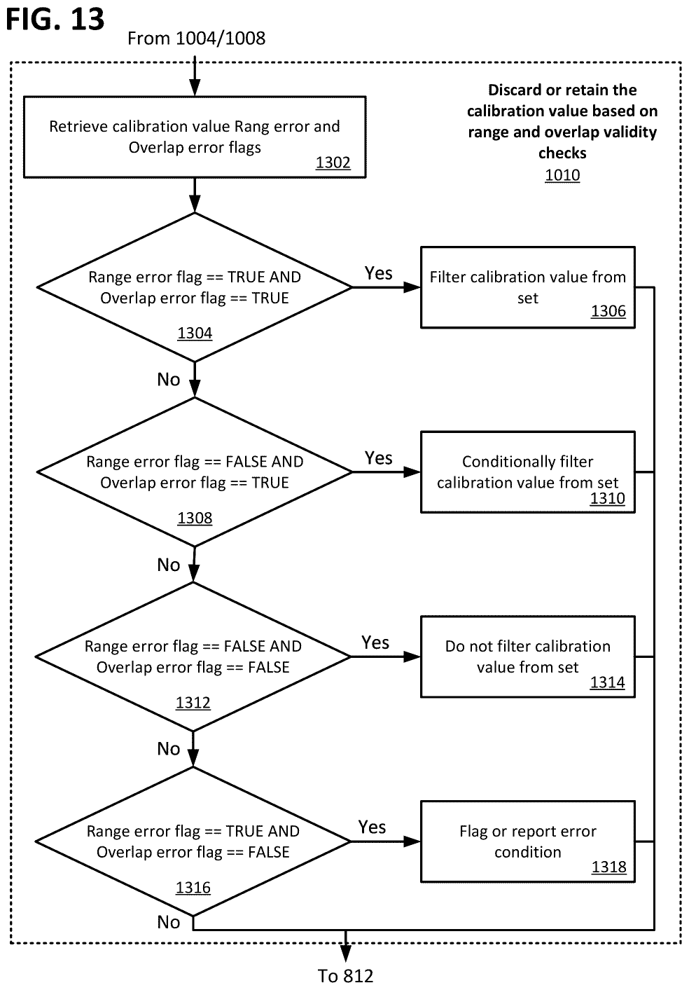

Steps 1002/1004 and 1006/1008 shown in FIG. 10 may be performed in parallel, sequentially, or in any other order. At step 1002, a previously stored aggregated calibration value overlap region (i.e., determined at step 904 of FIG. 9) is retrieved by the mobile device and/or server. At step 1004, the calibration value is validated by the mobile device and/or server using the retrieved aggregated calibration value overlap region. Details of step 1004 are described below with reference to FIG. 11. Flow then continues to step 1010, whereupon the calibration value is either filtered or retained (and later used) based on the overlap and range validity checks from steps 1004 and 1008. Details of step 1010 are described below with reference to FIG. 13.

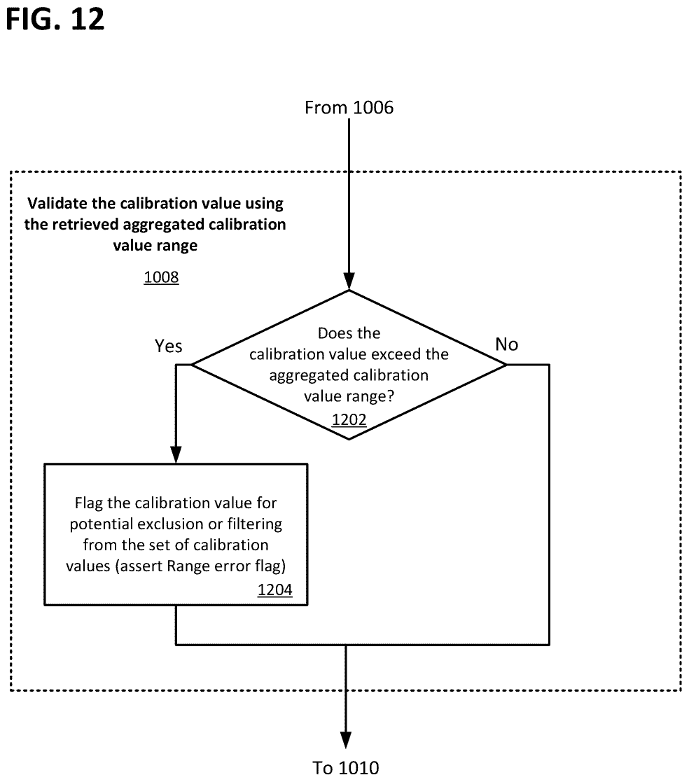

At step 1006, a previously stored aggregated calibration value range (i.e., determined at step 906 of FIG. 9) is retrieved by the mobile device and/or server. At step 1008, the calibration value is validated by the mobile device and/or server using the retrieved aggregated calibration value range. Details of step 1008 are described below with reference to FIG. 12.

FIG. 11 provides details for step 1004 introduced in FIG. 10 for validating the calibration value using the retrieved aggregated calibration value overlap region, in accordance with some embodiments. The particular steps, order of steps, and combination of steps are shown for illustrative and explanatory purposes only. Other embodiments can implement different particular steps, orders of steps, and combinations of steps to achieve similar functions or results.

At step 1102, it is determined if the calibration value partially or entirely falls outside of (“exceeds”) the aggregated calibration value overlap region. A calibration value that is entirely outside of the aggregated calibration value overlap region has a minimum confidence value that is greater than a maximum confidence value of the aggregated calibration value overlap region (e.g., the calibration values 1408a-c shown in FIG. 14), or a maximum confidence value that is less than a minimum confidence value of the aggregated calibration value overlap region (e.g., the calibration value 1408f shown in FIG. 14). A calibration value that is partially outside of the aggregated calibration value overlap region has either i) a minimum confidence value that is less than a maximum confidence value of the aggregated calibration value overlap region and a maximum confidence value that is greater than the maximum confidence value of the aggregated calibration value overlap region, or ii) a maximum confidence value that is greater than a minimum confidence value of the aggregated calibration value overlap region and a minimum confidence value that is less than the minimum confidence value of the aggregated calibration value overlap region.

In some embodiments, a calibration value is considered to partially or entirely fall outside of the aggregated calibration value overlap region if the confidence values thereof are partially or entirely outside of the aggregated calibration value overlap region, plus-or-minus a threshold buffer amount (e.g., based on a desired or required maximum amount of error, based on a normal maximum floor-to-floor separation value for a building (e.g., 3 meters), a buffer amount such as 2 m, or another appropriate value). The threshold buffer amount may account for calibration noise or other calibration quality issues. In addition, in some embodiments, determining whether a calibration value partially or entirely falls outside of the aggregated calibration value overlap region may be based on a percentage threshold relative to the overlap region itself (e.g. +/−20%, which means for a 5-10 m overlap region, a calibration value would need to fall outside of an adjusted overlap region of 4-12 m). Other methods can be considered.

For example, with reference to FIG. 14, calibration values 1408d-e are both numerically within the calibration value overlap region 1410. That is, neither the calibration offsets (illustrated by a dot or X) nor the minimum and maximum calibration confidence values at the boundaries (illustrated by error bars) of the calibration values 1408d-e partially or fully fall outside of the minimum and maximum values of the overlap region 1410. By comparison, each of the calibration values 1408a-c and 1408f fully falls outside of the overlap region 1410.

If it were determined at step 1102 that the calibration value partially or fully falls outside of the aggregated calibration value overlap region, flow continues to step 1104. At step 1104, the calibration value is flagged by asserting a parameter (e.g., setting an “overlap error flag” value to TRUE) in a database by the mobile device or server to indicate that the calibration value should potentially be removed or not added to the set of calibration values. Flow then continues back to step 1010 shown in FIG. 10.

If it was determined at step 1102 that the calibration value does not partially or fully fall outside of the aggregated calibration region, flow continues back to step 1010 shown in FIG. 10 without flagging the calibration value for potential removal from the set of calibration values.

FIG. 12 provides details for step 1008 introduced in FIG. 10 for validating the calibration value using the retrieved aggregated calibration value range, in accordance with some embodiments. The particular steps, order of steps, and combination of steps are shown for illustrative and explanatory purposes only. Other embodiments can implement different particular steps, orders of steps, and combinations of steps to achieve similar functions or results.

At step 1202, it is determined if the calibration value partially or fully falls outside of (“exceeds”) the aggregated calibration value range. For example, with reference to FIG. 14, calibration values 1408b-h are all numerically within the aggregated calibration value range 1412, whereas the calibration value 1408a is fully outside of the calibration value range 1412. If it was determined at step 1202 that the calibration value, including the plus-or-minus confidence values (i.e., the error bars), partially or fully falls outside of the aggregated calibration value range, flow continues to step 1204. At step 1204, the calibration value is flagged by asserting a parameter (e.g., setting a “range error flag” to TRUE) in a database by the mobile device or server to indicate that the calibration value should potentially be removed or not added to a set of validated calibration values. Flow then continues to step 1010 shown in FIG. 10. If it was determined at step 1202 that the calibration value does not partially or fully fall outside of the aggregated calibration value range, flow continues to step 1010 without flagging the calibration value for potential omission or removal from the set of validated calibration values.

FIG. 13 provides details for step 1010 introduced in FIG. 10 for filtering or retaining the calibration value based on the range and overlap validity checks, in accordance with some embodiments. The particular steps, order of steps, and combination of steps are shown for illustrative and explanatory purposes only. Other embodiments can implement different particular steps, orders of steps, and combinations of steps to achieve similar functions or results.

At step 1302, the previously determined calibration value overlap and range error flags associated with the calibration value (i.e., determined at step 1104 and 1204 shown in FIG. 11 and FIG. 12, respectively) are retrieved (e.g., from a database) by the mobile device or server. At step 1304, it is determined if the range error flag and the overlap error flag for the calibration value have both been asserted (i.e., whether the overlap error flag for the calibration value was asserted at step 1104 and the range error flag for the calibration value was asserted at step 1204). With reference to FIG. 14, the calibration value 1408a is an example of a calibration value that would be associated with both an asserted range error flag and an asserted overlap error flag. This is because the calibration value 1408a falls outside of both the aggregated calibration value overlap region 1410 and the aggregated calibration value range 1412.

If the range error flag and the overlap error flag have both been asserted, the calibration value is likely erroneous. Thus, if it is determined at step 1304 that the range error flag and the overlap error flag for the calibration value have both been asserted, flow continues to step 1306 whereupon the calibration value is excluded or filtered from the set of validated calibration values, or de-weighted within the set of validated calibration values. Flow then continues to step 812 shown in FIG. 8.

De-weighting a calibration value within the set of validated calibration values involves applying a weight to the calibration value such that the calibration value contributes less to an aggregated or combined calibration value generated using the set of validated calibration values as compared to if the calibration value was not de-weighted. In some embodiments, the weights applied to the calibration values when determining a combined calibration value may be a function of the difference between the calibration offset value, plus-or-minus the calibration confidence value as compared to the range and overlap values. In other embodiments, the weights applied to the calibration values when determining a combined calibration value may be a function of the difference between the calibration offset value, plus-or-minus the calibration confidence value, as compared to the range and overlap values, plus-or-minus a calibration confidence value. In yet other embodiments, the weights applied to each calibration value when determining a combined calibration value may be 0 if that particular calibration value is fully outside of a calibration overlap and/or range, 1 if that particular calibration value is fully within the calibration overlap and/or range, and a value in-between 0 and 1 if that particular calibration value is partially within the calibration overlap and/or range. In such embodiments, the weight applied to that particular calibration value may be based on the degree to which that calibration value is within the calibration overlap and/or range.

If it was determined at step 1304 that the range error flag and overlap error flag for the calibration value were not both asserted, flow continues to step 1308. At step 1308, it is determined if the range error flag for the calibration value has not been asserted, but the overlap error flag for the calibration value has been asserted. With reference to FIG. 14, the calibration values 1408b-c and 1408f are examples of calibration values that would be associated with a de-asserted range error flag and an asserted overlap error flag. This is because the calibration values 1408b-c and 1408f are outside of the aggregated calibration value overlap region 1410 but do not partially or fully fall outside of the aggregated calibration value range 1412.

If it is determined at step 1308 that the range error flag was de-asserted and the overlap flag for the calibration value was asserted, flow continues to step 1310. At step 1310, the calibration value is conditionally excluded or filtered from the set of validated calibration values or de-weighted. Flow then continues to step 812 of FIG. 8.

In some embodiments, conditionally filtering a calibration value from the set of validated calibration values involves performing additional validation checks on the calibration value such as evaluating the calibration for Indoor/Outdoor quality and then filtering the calibration value (e.g., adjusting a weighting or including/excluding the calibration value) from the set of validated calibration values based on the additional validation checks. That is, if the calibration value is determined (e.g., by evaluating the calibration value range) to have been generated using atmospheric data collected in an indoor environment but having an incorrect 2D position, the calibration value may be contextualized using techniques described in U.S. Pat. No. 10,514,258, which was issued on Dec. 24, 2019, and is entitled “Systems and Methods for Calibrating Unstable Sensors”, all of which is incorporated herein by reference in its entirety for all purposes.

In other embodiments, conditionally filtering the calibration value from the set of validated calibration values involves weighting the calibration value such that it provides less contribution to a combined calibration value determined using the set of validated calibration values as compared to a calibration value that has not been conditionally filtered, but contributes more to the combined calibration value than a calibration value that has been de-weighted at step 1306.

In some embodiments, candidate calibration values that were initially filtered or excluded from the set of validated calibration values may later be added to, or may be weighted such that they contribute more to the set of validated calibration values based on new data that has been collected. For example, a candidate calibration value that was initially excluded or filtered from a set of validated calibration values because it was outside of a permissible range of calibration values may be re-evaluated as the permissible range of calibration values changes.

If it was not determined at step 1308 that the range error flag was de-asserted and the overlap error flag was asserted, flow continues to step 1312. At step 1312, it is determined if both the range error flag and the overlap error flag for the calibration value have been de-asserted. With reference to FIG. 14, the calibration values 1408d-e are examples of calibration values that would be associated with a de-asserted range error flag and a de-asserted overlap error flag. This is because the calibration values 1408d-e are both within the overlap region 1410 and do not exceed the calibration value range 1412 as they do not partially or fully fall outside of the aggregated calibration value overlap region 1410 or the aggregated calibration range 1412. If it is determined at step 1312 that the range error flag and the overlap flag for the calibration value are both de-asserted, flow continues to step 1314. Otherwise, flow continues to step 1316.

At step 1314, the calibration value is added to, or retained, in the set of validated calibration values, and/or is assigned a weight such that the calibration value provides a greater contribution to a combined calibration value as compared to a calibration value that has been filtered or conditionally filtered. Flow then continues to step 812 of FIG. 8.

At step 1316, it is determined if the range error flag for the calibration value has been asserted and the overlap error flag for the calibration value has been de-asserted. As shown with reference to FIG. 14, such a condition cannot occur as the aggregated calibration value range 1412 will always match or exceed the overlap region 1410. As such, if it is determined at step 1316 that the range error flag for the calibration value has been asserted and the overlap error flag for the calibration value has been de-asserted, flow continues to step 1318. Otherwise, flow continues to step 812 shown in FIG. 8.

At step 1318, an error condition is flagged or reported by the mobile device and/or server. With reference to FIG. 14, an error condition is flagged in this scenario because it is not likely that a calibration value would be numerically within the overlap region 1410 but also partially or fully falls outside of the aggregated calibration value range 1412, and could indicate an issue with the flag determinations.

With further reference to the example shown in FIG. 14, calibration values 1408a-f may represent calibration values that were determined using atmospheric measurements made by a mobile device while it was assumed to be outdoors (e.g., based on an estimated position of the mobile device and a building database, or as described in U.S. Pat. No. 9,998,874, which issued on Jun. 12, 2018, and is entitled “Altitude-Based Indoor or Outdoor Detection”, all of which is incorporated herein by reference in its entirety for all purposes), and the calibration values 1408g-h may represent calibration values that were determined using atmospheric measurements made by the mobile device while it was assumed to be indoors. The calibration values 1408a-h may be determined in any sequence. This means that some erroneous calibration values will not be flagged as erroneous calibration values until additional calibration values are determined. For example, the calibration values 1408a-c and 1408f may not be flagged as being potentially erroneous until the calibration values 1408g-h have been determined. Additionally, some potentially erroneous calibration values may not be flagged as being potentially erroneous until calibration values associated with different floors of the same building or a different building have been determined. For example, if the calibration value 1408g had been determined, but the calibration value 1408h had not yet been determined, the resultant calibration value overlap region and aggregated calibration value range would likely be equal. Therefore, the calibration values 1408a and 1408f would be flagged for removal (i.e., at step 1306) as they are outside both the range and overlap of 1408g, but calibration values 1408b-d would not be flagged for removal since they would be within both the overlap region range.

In the example shown, the calibration value 1408a was determined when the mobile device was outdoors at a location that was different than the estimated position of the mobile device. The calibration value 1408b was determined using data collected at the top floor of a building but was incorrectly associated with an outdoor location based on an erroneous estimated position of the mobile device. The calibration value 1408c was determined inside of a building on a middle floor, but once again, was incorrectly associated with an outdoor location based on an erroneous estimated position of the mobile device. Similarly, the calibration value 1408d was determined inside of a building on a bottom floor but was incorrectly associated with an outdoor location. Each of the calibration values 1408b-d have small calibration confidence values based on the assumption that they were generated outdoors and have a narrow range of possible altitudes to calibrate against. The calibration value 1408d happens to be within both the aggregated calibration value range 1412 and the calibration value overlap region 1410 despite being associated with an incorrect location, due to the mobile device fortunately being on the ground floor of a building when the calibration value 1408d was determined, and therefore close to the terrain. As such, the altitude of the mobile device at that location was the same or similar to the altitude of the mobile device had it truly been outdoors.

The calibration value 1408e is an example of a calibration value that was determined using atmospheric measurements made by the mobile device when it was outdoors and also had an estimated position that matched the true location of the mobile device. By comparison, the calibration value 1408f was determined using atmospheric measurements made by the mobile device when it was outdoors, but the estimated position placed the mobile device at the wrong location (possibly in a tunnel or underground structure). As shown, by using the aggregated calibration value overlap region 1410 and the aggregated calibration value range 1412 to validate calibration values, erroneous calibration values may be advantageously excluded, filtered, or de-weighted from the calibration value data set.

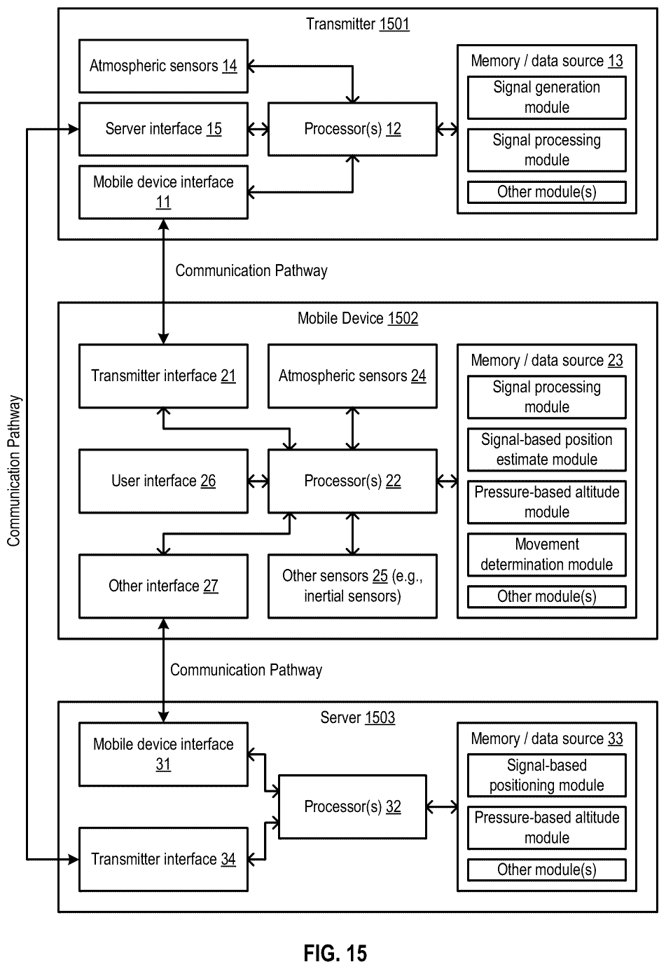

FIG. 15 illustrates components of an example transmitter 1501 (e.g., one of the transmitters 110a-b), an example mobile device 1502 (e.g., one of the mobile devices 120a-e), and an example server 1503 (e.g., any one of the servers 130) of the operational environment 100 shown in FIG. 1, in accordance with some embodiments. Examples of communication pathways are shown by arrows between components. The components shown in FIG. 15 are operable to perform all or a portion of the processes 200 and/or 800.

By way of example in FIG. 15, each of the transmitters 1501 may include: a mobile device interface 11 for exchanging information with a mobile device (e.g., antenna(s) and RF front-end components known in the art or otherwise disclosed herein); one or more processor(s) 12; memory/data source 13 for providing storage and retrieval of information and/or program instructions; atmospheric sensor(s) 14 for measuring environmental conditions (e.g., pressure, temperature, humidity, other) at or near the transmitter; a server interface 15 for exchanging information with a server (e.g., an antenna, a network interface, or other); and any other components known to one of ordinary skill in the art. The memory/data source 13 may include a memory storing software modules with executable instructions, and the processor(s) 12 may perform different actions by executing the instructions from the modules, including (i) performance of a part or all of the methods as described herein or otherwise understood by one of skill in the art as being performable at the transmitter; (ii) generation of positioning signals for transmission using a selected time, frequency, code, and/or phase; (iii) processing of signals received from the mobile device or another source; or (iv) other processing as required by operations described in this disclosure. Signals generated and transmitted by a transmitter may carry different information that, once determined by a mobile device or a server, may identify the following: the transmitter; the transmitter's position; environmental conditions at or near the transmitter; and/or other information known in the art. The atmospheric sensor(s) 14 may be integral with the transmitter, or separate from the transmitter and either co-located with the transmitter or located in the vicinity of the transmitter (e.g., within a threshold amount of distance).

By way of example in FIG. 15, the mobile device 1502 may include: a transmitter interface 21 for exchanging information with a transmitter (e.g., an antenna and RF front-end components known in the art or otherwise disclosed herein); one or more processor(s) 22; memory/data source 23 for providing storage and retrieval of information and/or program instructions; atmospheric sensor(s) 24 (such as barometers and temperature sensors) for measuring environmental conditions (e.g., pressure, temperature, other) at the mobile device; other sensor(s) 25 for measuring other conditions (e.g., inertial sensors for measuring movement and orientation); a user interface 26 (e.g., display, keyboard, microphone, speaker, other) for permitting a user to provide inputs and receive outputs; another interface 27 for exchanging information with the server or other devices external to the mobile device (e.g., an antenna, a network interface, or other); and any other components known to one of ordinary skill in the art. A GNSS interface and processing unit (not shown) are contemplated, which may be integrated with other components (e.g., the interface 21 and the processors 22) or a standalone antenna, RF front end, and processors dedicated to receiving and processing GNSS signaling. The memory/data source 23 may include a memory (e.g., a data storage module) storing software modules with executable instructions, and the processor(s) 22 may perform different actions by executing the instructions from the modules, including (i) performance of a part or all of the methods as described herein or otherwise understood by one of ordinary skill in the art as being performable at the mobile device; (ii) estimation of an altitude of the mobile device based on measurements of pressure from the mobile device and transmitter(s), temperature measurement(s) from the transmitter(s) or another source, and any other information needed for the computation); (iii) processing of received signals to determine position information (e.g., times of arrival or travel time of the signals, pseudoranges between the mobile device and transmitters, transmitter atmospheric conditions, transmitter and/or locations or other transmitter information); (iv) use of position information to compute an estimated position of the mobile device; (v) determination of movement based on measurements from inertial sensors of the mobile device; (vi) GNSS signal processing; or (vii) other processing as required by operations described in this disclosure.

By way of example in FIG. 15, the server 1503 may include: a mobile device interface 31 for exchanging information with a mobile device (e.g., an antenna, a network interface, or other); one or more processor(s) 32; memory/data source 33 for providing storage and retrieval of information and/or program instructions; a transmitter interface 34 for exchanging information with a transmitter (e.g., an antenna, a network interface, or other); and any other components known to one of ordinary skill in the art. The memory/data source 33 may include a memory storing software modules with executable instructions, and the processor(s) 32 may perform different actions by executing instructions from the modules, including (i) performance of a part or all of the methods as described herein or otherwise understood by one of ordinary skill in the art as being performable at the server; (ii) estimation of an altitude of the mobile device; (iii) computation of an estimated position of the mobile device; or (iv) other processing as required by operations described in this disclosure. Steps performed by servers as described herein may also be performed on other machines that are remote from a mobile device, including computers of enterprises or any other suitable machine.

Certain aspects disclosed herein relate to estimating the positions of mobile devices—e.g., where the position is represented in terms of latitude, longitude, and/or altitude coordinates; x, y, and/or z coordinates; angular coordinates; or other representations. Various techniques to estimate the position of a mobile device can be used, including trilateration, which is the process of using geometry to estimate the position of a mobile device using distances traveled by different “positioning” (or “ranging”) signals that are received by the mobile device from different beacons (e.g., terrestrial transmitters and/or satellites). If position information like the transmission time and reception time of a positioning signal from a beacon is known, then the difference between those times multiplied by the speed of light would provide an estimate of the distance traveled by that positioning signal from that beacon to the mobile device. Different estimated distances corresponding to different positioning signals from different beacons can be used along with position information like the locations of those beacons to estimate the position of the mobile device. Positioning systems and methods that estimate a position of a mobile device (in terms of latitude, longitude, and/or altitude) based on positioning signals from beacons (e.g., transmitters, and/or satellites) and/or atmospheric measurements are described in co-assigned U.S. Pat. No. 8,130,141, issued Mar. 6, 2012, and U.S. Pat. No. 9,057,606, issued Jun. 16, 2015, all of which are incorporated herein by reference in their entirety for all purposes. It is noted that the term “positioning system” may refer to satellite systems (e.g., Global Navigation Satellite Systems (GNSS) like GPS, GLONASS, Galileo, and Compass/Beidou), terrestrial transmitter systems, and hybrid satellite/terrestrial systems.

Reference has been made in detail to embodiments of the disclosed invention, one or more examples of which have been illustrated in the accompanying figures. Each example has been provided by way of an explanation of the present technology, not as a limitation of the present technology. In fact, while the specification has been described in detail with respect to specific embodiments of the invention, it will be appreciated that those skilled in the art, upon attaining an understanding of the foregoing, may readily conceive of alterations to, variations of, and equivalents to these embodiments. For instance, features illustrated or described as part of one embodiment may be used with another embodiment to yield a still further embodiment. Thus, it is intended that the present subject matter covers all such modifications and variations within the scope of the appended claims and their equivalents. These and other modifications and variations to the present invention may be practiced by those of ordinary skill in the art, without departing from the scope of the present invention, which is more particularly set forth in the appended claims. Furthermore, those of ordinary skill in the art will appreciate that the foregoing description is by way of example only, and is not intended to limit the invention.

What is claimed is:

1. A method, comprising:
measuring, by one or more processors, atmospheric pressure data using a barometric pressure sensor of a mobile device;
determining, by the one or more processors, an estimated position of the mobile device using positioning data received at the mobile device;
determining, by the one or more processors, a calibration value for calibrating the barometric pressure sensor of the mobile device using the atmospheric pressure data;
adding, by the one or more processors, the calibration value to a set of calibration values;
determining, by the one or more processors, if the estimated position of the mobile device corresponds to a location that has a wide distribution of possible altitudes;
upon determining that the mobile device is at a position that has a wide distribution of possible altitudes, generating, by the one or more processors, an aggregated calibration value overlap region and an aggregated calibration value range using the set of calibration values;
generating, by the one or more processors, a set of validated calibration values by validating the set of calibration values using a previously generated aggregated calibration value overlap region and a previously generated aggregated calibration value range;
generating, by the one or more processors, a combined calibration value using the set of validated calibration values; and
calibrating, by the one or more processors, the barometric pressure sensor using the combined calibration value.

2. The method of claim 1, wherein determining if the estimated position corresponds to a location that has a wide distribution of possible altitudes comprises:
retrieving, by the one or more processors, terrain data based on the estimated position of the mobile device;
determining, by the one or more processors, a deviation of altitudes associated with the estimated position of the mobile device using the retrieved terrain data; and
upon determining, by the one or more processors, that the deviation of altitudes partially or fully falls outside of a threshold value, determining that the location is considered to have a wide distribution of possible altitudes.

3. The method of claim 1, wherein:
the aggregated calibration value range is generated using one of i) a combined measure of a spread of the calibration values in the set of calibration values, ii) a calculated difference between an absolute maximum and absolute minimum calibration value of the set of calibration values, or iii) a measure of dispersion from a central tendency of the calibration values in the set of calibration values.

4. The method of claim 1, wherein:
each calibration value of the set of calibration values comprises a calibration offset value and a calibration confidence value; and
the aggregated calibration value overlap region is generated using a numerical span in which the calibration confidence values of two or more calibration values numerically overlap with one another.

5. The method of claim 1, wherein validating the set of calibration values comprises:
retrieving, by the one or more processors, the previously generated aggregated calibration value overlap region;
generating, by the one or more processors, an overlap error flag value associated with the calibration value based on a comparison of the calibration value to the retrieved aggregated calibration value overlap region;
retrieving, by the one or more processors, the previously generated aggregated calibration value range; and
generating, by the one or more processors, a range error flag value associated with the calibration value based on a comparison of the calibration value to the retrieved aggregated calibration value range.

6. The method of claim 5, wherein generating the overlap error flag value associated with the calibration value comprises:
upon determining, by the one or more processors, that the calibration value exceeds the aggregated calibration value overlap region, asserting the overlap error flag for that calibration value.

7. The method of claim 5, wherein generating the range error flag value associated with the calibration value comprises:
upon determining, by the one or more processors, that the calibration value exceeds the aggregated calibration value range, asserting the range error flag for that calibration value.

8. The method of claim 5, further comprising:
upon determining, by the one or more processors, that the range error flag is asserted and that the overlap error flag is asserted, filtering the calibration value from the set of calibration values to generate the set of validated calibration values; and
upon determining, by the one or more processors, that the range error flag is not asserted and that the overlap error flag is not asserted, not filtering the calibration value from the set of calibration values to generate the set of validated calibration values.

9. The method of claim 8, wherein filtering the calibration value from the set of calibration values to generate the set of validated calibration values comprises:
weighting, by the one or more processors, a contribution of the calibration value to the combined calibration value such that the calibration value contributes less to the combined calibration value as compared to a calibration value that was not filtered from the set of calibration values.

10. The method of claim 5, further comprising:
upon determining, by the one or more processors, that the range error flag is not asserted and that the overlap error flag is asserted, conditionally filtering the calibration value from the set of calibration values to generate the set of validated calibration values.

11. The method of claim 10, wherein conditionally filtering the calibration value from the set of calibration values to generate the set of validated calibration values comprises:
performing, by the one or more processors, additional validation checks on the calibration value; and
filtering, by the one or more processors, the calibration value from the set of calibration values based on the additional validation checks.

12. The method of claim 5, further comprising:
upon determining, by the one or more processors, that the range error flag is asserted and that the overlap error flag is not asserted, generating an error condition flag.

13. The method of claim 1, wherein generating the combined calibration comprises:
determining a first low end and a first high end of a first calibration value of the set of calibration values;
determining a second low end and a second high end of a second calibration value of the set of calibration values;
determining a numerical overlap region having a low overlap end that is equal to the higher value of the first low end and the second low end, and a high overlap end that is equal to the lower value of the first high end and the second high end; and
determining the combined calibration value as having a combined calibration offset value equal to a midpoint of the numerical overlap region and having a combined calibration confidence value equal to half of an extent of the numerical overlap region.

14. A method, comprising:
measuring, by one or more processors, atmospheric pressure data using a barometric pressure sensor of a mobile device;
determining, by the one or more processors, an estimated position of the mobile device;
determining, by the one or more processors, a calibration value for calibrating the barometric pressure sensor of the mobile device using the atmospheric pressure data;
adding, by the one or more processors, the calibration value to a set of calibration values;
generating, by the one or more processors, a set of validated calibration values by validating the set of calibration values using a previously generated aggregated calibration value overlap region and a previously generated aggregated calibration value range;
generating, by the one or more processors, a combined calibration value using the set of validated calibration values; and
calibrating, by the one or more processors, the barometric pressure sensor using the combined calibration value.

15. The method of claim 14, wherein:
the previously generated aggregated calibration value range was generated using one of i) a combined measure of a spread of the calibration values in the set of calibration values, ii) a calculated difference between an absolute maximum and absolute minimum calibration value of the set of calibration values, or iii) a measure of dispersion from a central tendency of the calibration values in the set of calibration values.

16. The method of claim 14, wherein:
each calibration value of the set of calibration values comprises a calibration offset value and a calibration confidence value; and
the previously generated aggregated calibration value overlap region was generated using a numerical span in which the calibration confidence values of two or more calibration values numerically overlap with one another.

17. The method of claim 14, wherein validating the calibration value using a previously generated aggregated calibration value overlap region and a previously generated aggregated calibration value range comprises:
retrieving, by the one or more processors, the previously generated aggregated calibration value overlap region;
validating, by the one or more processors, the calibration value using the retrieved aggregated calibration value overlap region to generate an overlap error flag;
retrieving, by the one or more processors, the previously generated aggregated calibration value range; and
validating, by the one or more processors, the calibration value using the retrieved aggregated calibration value range to generate a range error flag.

18. The method of claim 17, further comprising:
upon determining, by the one or more processors, that the range error flag is asserted and that the overlap error flag is asserted, filtering the calibration value from the set of calibration values to generate the set of validated calibration values; and
upon determining, by the one or more processors, that the range error flag is not asserted and that the overlap error flag is not asserted, not filtering the calibration value from the set of calibration values to generate the set of validated calibration values.

19. The method of claim 14, wherein generating the combined calibration comprises:
determining a first low end and a first high end of a first calibration value of the set of calibration values;
determining a second low end and a second high end of a second calibration value of the set of calibration values;
determining a numerical overlap region having a low overlap end that is equal to the higher value of the first low end and the second low end, and a high overlap end that is equal to the lower value of the first high end and the second high end; and
determining the combined calibration value as having a combined calibration offset value equal to a midpoint of the numerical overlap region and having a combined calibration confidence value equal to half of an extent of the numerical overlap region.
